(19) United States
(12) Patent Application Publication
(10) Pub. No.: US 2007/0221651 A1
(43) Pub. Date: Sep. 27, 2007

(54) Cooking vessel with lid

(76) Inventors: J. Genslak Kristina, St. Joseph, MI (US); Michael P. Conti, St. Joseph, MI (US)

Correspondence Address: WHIRLPOOL PATENTS COMPANY - MD 0750, 500 RENAISSANCE DRIVE - SUITE 102, ST. JOSEPH, MI, 49085, US

(21) Appl. No.: 11/386,403

(22) Filed: Mar. 22, 2006

(51) Int. Cl. F27D 11/00

(52) U.S. Cl. 219/432

(57) ABSTRACT

A cooking vessel assembly having a cooking vessel and a lid. A shape-conforming element mounts to one of the lid and vessel to retarded heat or steam from migrating from the vessel between the lid and vessel.

### BACKGROUND OF THE INVENTION

1. Field of the Invention

The invention relates generally to cooking vessel assemblies and more particularly to a cover for a cooking vessel assembly.

2. Description of the Related Art

Glass covers are frequently used in cooking appliances such as slow cookers, roaster ovens, and the like and sit on a cooking pot rim in order to trap cooking heat and steam during the cooking process. Such covers are frequently finished along the perimeter with a bare glass edge or a rigid thin metal trim band. The glass edge or trim band sits on the cooking pot rim.

The fit of the glass lid on the cooking pot rim frequently does not provide a sufficient seal because the meeting parts are often produced with slight tolerance variations. This is particularly true with slow cookers and other cooking appliances that utilize crockery, stoneware, or a similar cooking vessel. Such tolerance variations produce small gaps leading to loss of cooking heat and moisture. This can negatively impact the cooking time as well as the quality of the cooked food item.

Bare glass edges are also prone to damage and can damage the mating surface of a crockery or stoneware cooking vessel. Additionally, covers with glass edges or metal trim bands can rattle and possibly inflict damage to the cooking vessel during transportation.

### SUMMARY OF THE INVENTION

A cooking vessel assembly includes a cooking vessel defining an interior volume and having an upper edge defining an opening to the interior volume. A lid for closing the opening and having a peripheral rim may be configured for cooperative disposition with the upper edge when the lid closes the opening, and a shape-conforming element may be mounted to one of the upper edge and the peripheral rim to conform with the other of the upper edge and peripheral rim when the lid closes the opening, whereby heat and steam are retarded from migrating out of the interior volume.

### BRIEF DESCRIPTION OF THE DRAWINGS

In the drawings:

FIG. 1 is a perspective view of a first embodiment of the invention in the form of a slow cooker having a lid with a shape-conforming element along a perimeter edge of the lid.

FIG. 2 is an exploded view of the slow cooker illustrated in FIG. 1.

FIG. 3 is a sectional view of the slow cooker illustrated in FIG. 1 taken along view line 3-3 of FIG. 1.

FIG. 3A is an enlarged view of a portion of the slow cooker illustrated in FIG. 3 illustrating the shape-conforming element attached to an edge of the lid.

FIG. 4 is a sectional view of a portion of a second embodiment of the invention in the form of a cover and a cooking vessel, the cooking vessel having a shape-conforming element attached to and extending along an edge of the cooking vessel.

FIG. 4A is an enlarged sectional view of the shape-conforming element illustrated in FIG. 4.

FIG. 5 is a sectional view of a portion of a third embodiment of the invention in the form of a cover and a cooking vessel, the cooking vessel having an alternative shape-conforming element attached to and extending along an edge of the cooking vessel.

FIG. 5A is an enlarged sectional view of the shape-conforming element illustrated in FIG. 5.

FIG. 6 is a sectional view of a portion of a fourth embodiment of the invention in the form of a cover and a cooking vessel, the cooking vessel having an alternative shape-conforming element attached to and extending along an edge of the cooking vessel.

FIG. 6A is an enlarged sectional view of the shape-conforming element illustrated in FIG. 6.

FIG. 7 is a sectional view of a portion of a fifth embodiment of the invention in the form of a cover and a cooking vessel, the cover having an alternative shape-conforming element in the configuration of a bead attached to and extending parallel to an edge of the cover.

### DESCRIPTION OF AN EMBODIMENT OF THE INVENTION

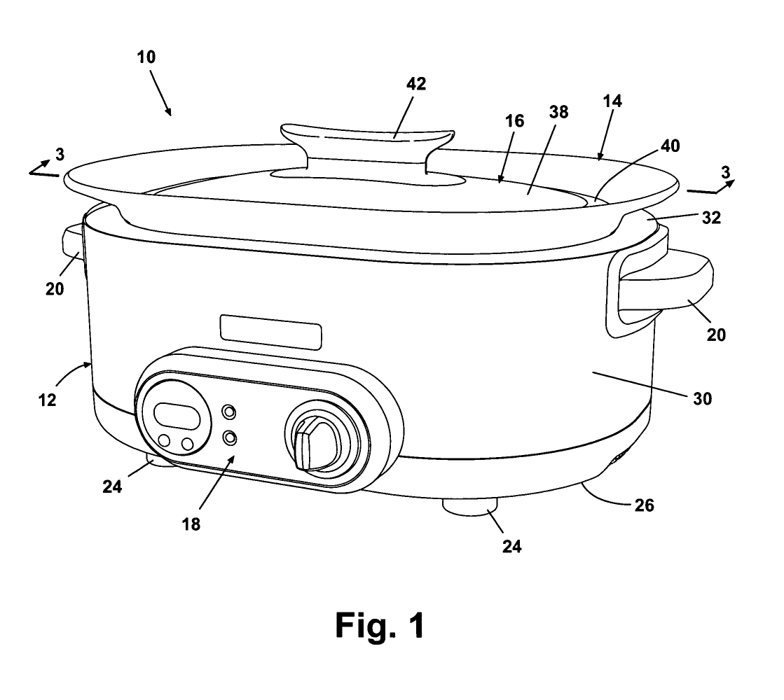

Referring now to FIG. 1, an embodiment of the invention is illustrated as a cooker 10 having a base 12, a cooking vessel 14, and a lid 16. The cooker 10 is illustrated as a slow cooker, although the invention may be incorporated into a countertop toaster or roaster oven, a rice cooker, a fondue pot, a deep fryer, a traditional cooking pot, pan, or baking dish, a BBQ pit, and the like). In the embodiment shown, the cooking vessel 14 and lid 16 form a cooking vessel assembly which can be removed from the base 12 for cleaning, replacement, or serving, although in other embodiments the cooking vessel 14 and the base 12 may be unitary.

The cooker 10 may also have a control panel 18 for controlling operation of the cooker 10 such as the cooking temperature, cooking time, preprogrammed heating cycles, on/off controls, and the like. Such operational controls are considered well known in the art, and will not be further described herein. Handles 20 provide a means of lifting and moving the cooker 10. The control panel 18 may be fixed to the machine or may be a separate control panel module that the appliance plugs into.

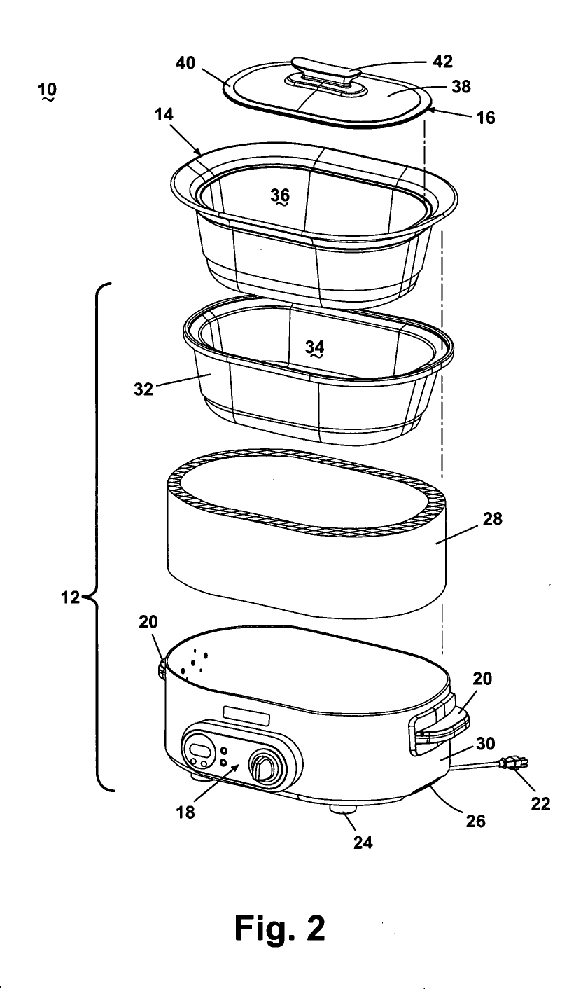

Referring to FIG. 2, according to one embodiment of the invention, the base 12 may be a generally well-known heating unit having a bottom wall 26 supporting a base wall 30 with a size and configuration adapted for enclosing the cooking vessel 14. The base wall 30 may receive an optional liner 32 and an optional insulation layer 28 disposed therebetween. The bottom wall 26 may be supported on a plurality of feet 24, although other supporting devices known to those skilled in the art may also be used. An electric power cord 22 may extend from the base 12, and may be operably connected to the control panel 18 for supplying power to a heating element (not shown) for heating the cooking vessel 14. In other embodiments of the invention the heating unit may be external to the cooker 10, such as in the case of a traditional cooking pot, pan, or baking dish. In FIG. 2, the base wall 30 and the bottom wall 24 are illustrated as oval shaped, although they can be round, square, or some other configuration complementary to the configuration of the cooking vessel 14. The base wall 30 can also be separate from the bottom wall 26 or omitted altogether, or alternatively, the base wall 30 and the bottom wall 26 can be a single, unitary structure.

A layer of insulation 28 conforming in general to the configuration of the base wall 30 may lie along the inner surface of the base wall 30 in order to retain heat in the cooking vessel 14 during cooking and maintain a relatively cooler temperature of the base wall 30. A liner 32 defining a chamber 34, may be received within the insulation layer 28 and be fixedly attached along a perimeter flange to the base wall 30 or by other ways known to those skilled in the art. A heating element (not shown) can be positioned between the liner 32 and the insulation layer 28 to heat the liner 32 and the cooking vessel 34. The heating element normally circumscribes the liner 32, e.g., along the walls, or alternately may be located along the floor of the liner 32, or both, although other configurations known to those skilled in the art may also be used.

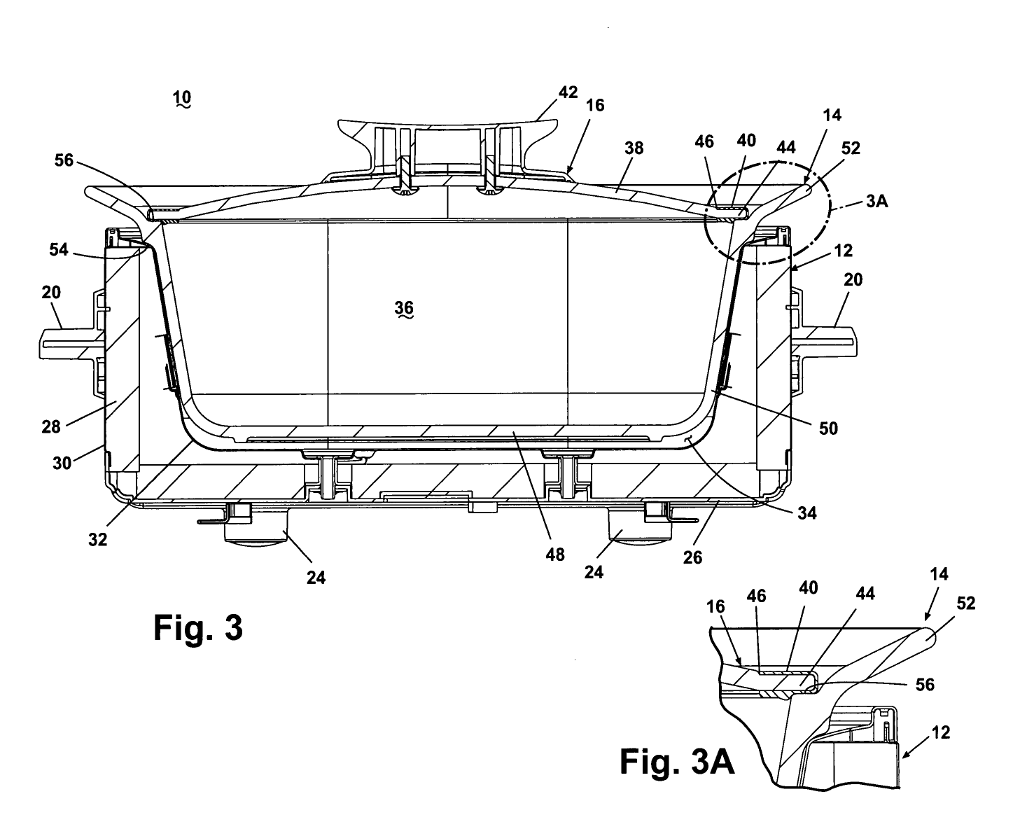

Referring to FIG. 3, according to one embodiment of the invention, as assembled, the liner 32, base wall 30, and bottom wall 26 form an enclosure in which the insulation 28 may be enclosed. The liner 32 can be fabricated of a heat conductive material capable of withstanding preselected cooking temperatures, such as steel, aluminum, and the like.

The cooking vessel 14 may be an open vessel having a configuration complementary to the liner chamber 34 and having a perimeter wall 50 and a bottom wall 48 defining a cooking cavity 36. The cooking vessel 14 may also comprise separate cooking cavities, through the use of one or more divider walls or the like, for the separate cooking of food items. The cooking vessel 14 can be placed within the chamber 34 for heating and cooking food items placed in the cooking cavity 36, and can be made of a suitable high temperature material, such as crockery, stoneware, a ceramic, and the like, or any of a variety of other materials known to those skilled in the art. The cooking vessel 14 is illustrated as removable from the chamber 34. Alternatively, the cooking vessel 14 can be permanently attached to the liner 32 to form a unitary structure with the base 12. In the embodiment shown, the perimeter wall 50 may transition to an upwardly and outwardly extending lip 52 to define a lower support surface 54 and an upper edge having an opposed upper support surface 56 extending perimetrically along the perimeter wall 50. The lower support surface 54 may engage a top edge of the liner 32 to support the cooking vessel 14 in the liner 32. The upper support surface 56 may support the lid 16 over the cooking cavity 36.

The lid 16 may have a configuration complementary to the cooking vessel 14 for support upon the upper support surface 56. The lid 16 may have a centrally disposed dome portion 38 transitioning to a handle 42, or in other embodiments it may be flat or an inverted dome. The dome portion 38 transitions through a break line 46 along an outer perimeter thereof to a flange-like rim 44. The rim 44 may be supported upon the upper support surface 56 in abutting relationship with the lip 52.

A shape-conforming element 40 may extend around all or parts of the rim 44 along the perimeter of the lid 16. The shape-conforming element 40 may be a material that will conform under the weight of the lid 16 to the areas of contact between the rim 44 and the perimeter of the lid 16, and provide a generally continuous seal and cushion along the areas of contact between the rim 44 and the perimeter of the lid 16, yet demonstrate robust construction and durability. The material should have the following properties: capable of repeated use at high cooking temperature conditions, i.e. heat resistant at cooking temperatures; capable of repeated cleaning in dishwasher and resistance to chemical cleaning agents without degradation; food-grade safe; soft or pliable; and resistant to stress cracking, due to the cooking heat/steam/moisture that is generated during the slow cooking process. An example of a suitable material is silicone. Nylon plastic may also be used, as well as any other material having the aforementioned properties.

The shape-conforming element may be fixedly or removably mounted to the rim 44, such that the shape-conforming element is carried by the lid. The particular form of mounting may include wrapping the shape-conforming element 40 about the perimetric edge of the rim 44 to seal the gap between the lid 16 and the upper support surface 56 when the lid 16 is seated on the cooking vessel 14. Alternatively, the shape-conforming element may be a bead of material, such as a silicone, interposed between the rim 44 and the upper support surface 56, and attached to either the rim 44 or the upper support surface 56, to seal the gap between the rim 44 and the upper support surface 56. The bead of material may be attached to the surface of the rim 44 or the upper support surface 56, or may be carried in a groove extending inwardly along the rim 44 or the upper support surface 56. The bead of material would have the properties described above.

As illustrated in FIG. 3A, when the lid 16 is seated on the upper support surface 56, the shape-conforming element 40 may be compressed along its contact with the upper support surface 56 to form a seal between the rim 44 of the lid 16 and the upper support surface 56 of the cooking vessel 14, which provides a thermal and moisture barrier between the lid 16 and the cooking vessel 14, thereby improving the performance of the cooker 10 and the quality of the cooked food item. The shape-conforming element 40 conforms to the upper support surface 56 to enhance the seal between the lid 16 and the cooking vessel 14. The shape-conforming element 40 improves the energy efficiency of the cooker 10 by reducing the cooking time as a result of reducing heat loss between the lid 16 and the cooking vessel 14. The cushioning effect of the shape-conforming element 40 reduces the potential for damage or breakage caused by contact between the rim 44 and the upper support surface 56, and reduces noise caused by the lid 16 rattling against the upper support surface 56 during movement of the cooker 10.

Although the shape-conforming element 40 conforms to the upper support surface 56, the seal between the shape-conforming element 40 and the upper support surface 56 will typically still vent some air and/or moisture, thereby minimizing the build-up of pressure within the cooking cavity 36. For example, one possible scenario for the venting of air/moisture will occur when the pressure inside the vessel is sufficient to overcome the force corresponding to the weight of the lid bearing on the shape-conforming element, which will cause a local break in the seal between the shape-conforming element 40 and the upper support surface through which the air/moisture may escape. Additionally, the material utilized for the shape-conforming element 40 and the geometries of the shape-conforming element 4, the lid 16, and the upper support surface 56 will vary the effectiveness of the seal.

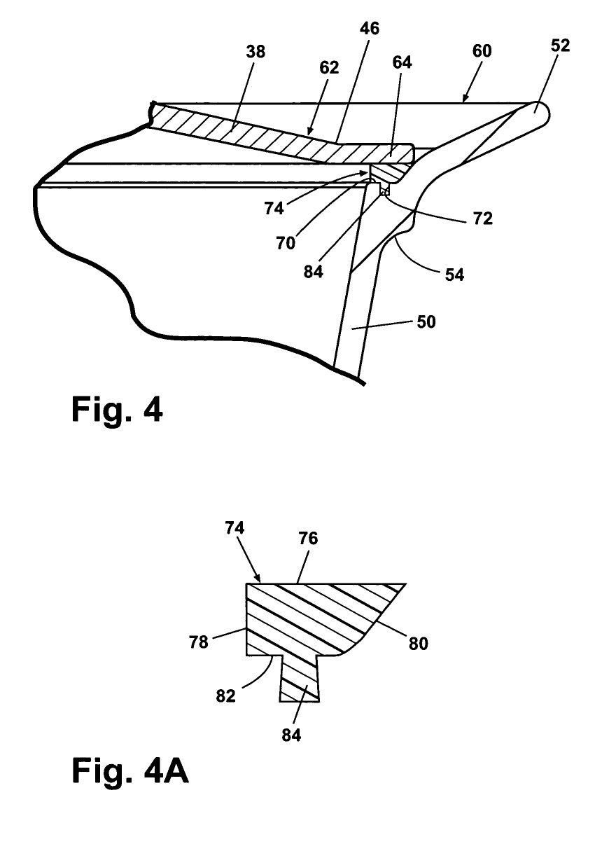

FIG. 4 illustrates a second embodiment of a shape-conforming element 74 according to the invention. Rather than being attached to the lid 16 as in the first embodiment, the shape-conforming element 74 may be attached to a cooking vessel 60 at an upper support surface 70 defined by the transition from the perimeter wall 50 to the lip 52. A channelway 72 may depend from the upper support surface 70 and extend perimetrically around some or all of the cooking vessel 60. A lid 62 shares many of the same features as the lid 16, except that the shape-conforming element 40 may be omitted, and the rim 44 may be configured accordingly to sit upon the shape-conforming element 74.

As illustrated in FIG. 4A, the shape-conforming element 74 has a top wall 76, an inner wall 78 depending downwardly from the top wall 76, an outer wall 80, and a bottom wall 82 joining the inner wall 78 and the outer wall 80. Referring again to FIG. 4, a rail 84 having a configuration complementary to the channelway 72 and adapted to removably hold the shape-conforming element 74 to the cooking vessel 60 depends generally orthogonally downwardly from the bottom wall 82. Thus, the shape-conforming element 74 can be removed from the cooking vessel 60 for cleaning or replacement, and readily installed by inserting the rail 84 in the channelway 72. The channelway 72 and rail 84 can be provided with a somewhat trapezoidal shape to enhance the interlocking of the rail 84 with the channelway 72.

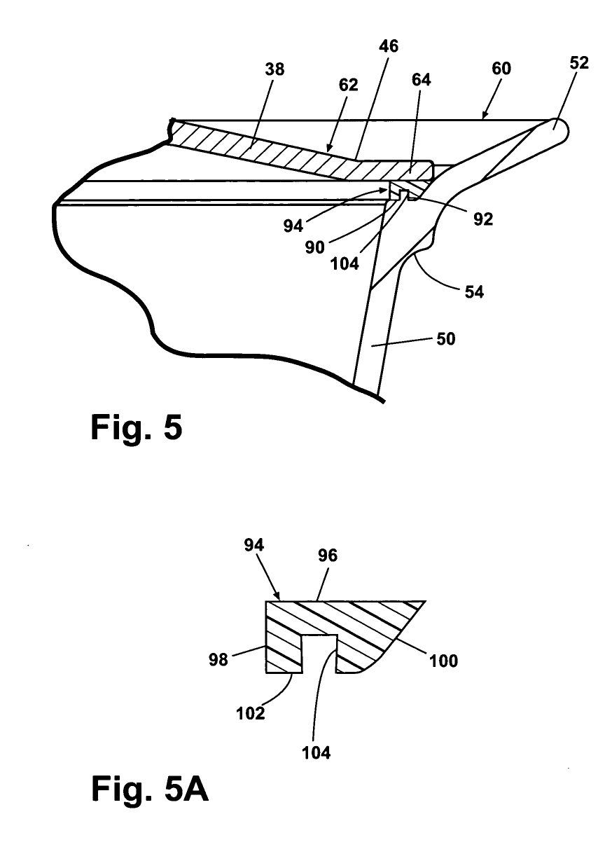

FIG. 5 illustrates a third embodiment of a shape-conforming element 94 according to the invention. A rail 92 may extend from the upper support surface 90 perimetrically around some or all of the cooking vessel 60. The rim 64 of the lid 62 sits upon the shape-conforming element 94. The shape-conforming element 94 includes a channelway 104 that receives the rail 92 to mount the shape-conforming element 94 to the vessel.

FIG. 5A shows the shape-conforming element in greater detail. The shape-conforming element 94 has a top wall 96, an inner wall 98 depending downwardly from the top wall 96, an outer wall 100, and a bottom wall 102 joining the inner wall 98 and the outer wall 100. The channelway 104 has a configuration complementary to the rail 92 and adapted to removably hold the shape-conforming element 94 to the cooking vessel 60, and extends generally orthogonally upwardly from the bottom wall 102 into the interior of the shape-conforming element 94. The rail 92 and channelway 104 can be provided with a somewhat trapezoidal shape to enhance the interlocking of the channelway 104 with the rail 92.

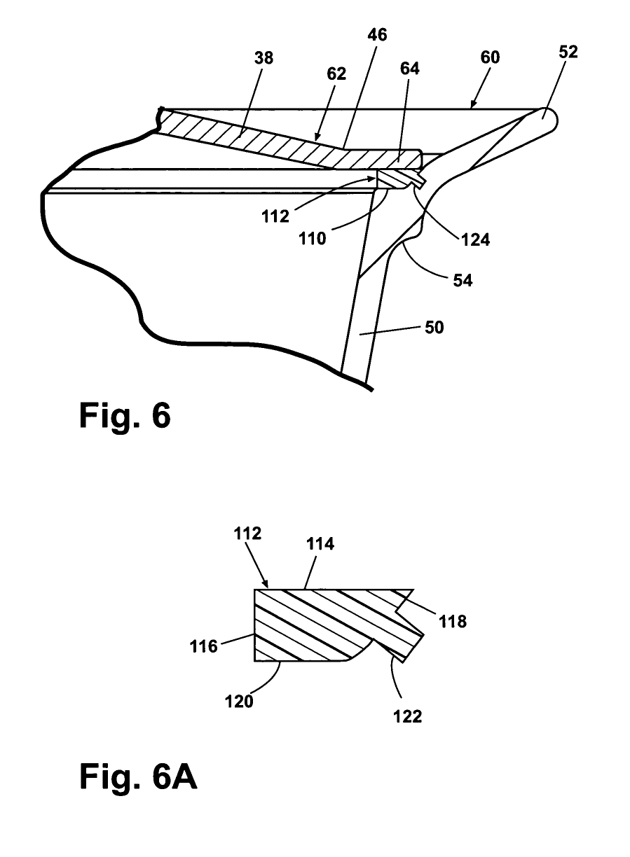

FIG. 6 illustrates a fourth embodiment of a shape-conforming element 112 according to the invention. The shape-conforming element 112 sits upon the upper support surface 110 of the cooking vessel 60 so that the rim 64 of the lid 62 sits upon the shape-conforming element 112. The shape-conforming element 112 includes a rail 122 that is received in a channelway 124 in the lip 52 to mount the shape-conforming element 112 to the vessel.

FIG. 6A shows the shape-conforming element in greater detail. The shape-conforming element 112 has a top wall 114, an inner wall 116 depending downwardly from the top wall 114, an outer wall 118, and a bottom wall 120 joining the inner wall 116 and the outer wall 118. The rail 122 extends generally orthogonally away from the outer wall to engage the channelway 124. The channelway 124 has a configuration complementary to the rail 122 and is adapted to removably hold the shape-conforming element 112 to the cooking vessel 60. The rail 122 and channelway 124 can be provided with a somewhat trapezoidal shape to enhance the interlocking of the channelway 124 with the rail 122.

FIG. 7 illustrates a fifth embodiment of a shape-conforming element 130 according to the invention in which the shape-conforming element 40 wrapping around the rim 44 is replaced by a bead 130 circumscribing a lower surface of the rim 44. The bead 130 may be of a material that is adhered by adhesive or other attachment methods known to those skilled in the art to the underside of the rim 44 so that it is interposed between the rim 44 and the upper support surface 56 to seal the gap between the rim 44 and the upper support surface 56. The bead 130 may be made from any of the previously described or defined materials. The bead 130 may have a circular or oval cross-section, and is illustrated in FIG. 7 as somewhat flattened due to the weight of the cover 16, thereby increasing the area of contact with the upper support surface 56 and enhancing the effectiveness of the seal between the rim 44 and the upper support surface 56. Alternatively, the bead 130 may be attached to the upper support surface 56, or may be segmented to provide gaps between the rim 44 and the upper support surface 56 to retard the migration of a portion of the heat and steam out of the cooking cavity during cooking. The bead 130 may also be seated in a groove (not shown) extending inwardly along the rim 44 or the upper support surface 56.

Alternatively, the shape-conforming element 74, 94, 112 can be attached to the upper support surface 70, 90, 110 with a glue or other adhesive in addition to or instead of the channelway 72, 104, 124 and rail 84, 92, 122. Other attachment methods and structures known to those skilled in the art may also be used.

In another embodiment, the cooker 10 can have both the lid 16 having the shape-conforming element 40 and the cooking vessel 60 having the shape-conforming element 74 to further enhance the heat and moisture seal. In yet another embodiment, the lid 16 can be provided with one or more vents for controlled venting of moisture and/or heat from the cooking cavity 36. The vents can also be provided with adjustable vanes to selectively adjust the size of the vents.

While the invention has been specifically described in connection with certain specific embodiments thereof, it is to be understood that this is by way of illustration and not of limitation. Reasonable variation and modification are possible within the scope of the forgoing disclosure and drawings without departing from the spirit of the invention which is defined in the appended claims.

What is claimed is:

1. A cooking vessel assembly, comprising:
a cooking vessel defining an interior volume and having a first portion defining an opening to the interior volume;
a lid configured to close at least a part of the opening, the lid having a second portion configured for cooperative disposition with the first portion when the lid closes at least a part of the opening; and
a shape-conforming element mounted to one of the first portion and the second portion and configured to conform with the other of the first portion and the second portion when the lid closes at least a part of the opening to retard heat and steam from migrating out of the interior volume between the lid and the cooking vessel during cooking.

2. The cooking vessel assembly according to claim 1 wherein the first portion is an edge on the vessel and the second portion is a peripheral rim on the lid.

3. The cooking vessel assembly according to claim 1 wherein the other of the first portion and the second portion has a profile and the shape-conforming element is configured to substantially conform to the profile when the lid closes the opening.

4. The cooking vessel assembly according to claim 1 wherein the shape-conforming element is configured to substantially form a seal between the cooking vessel and the lid.

5. The cooking vessel assembly according to claim 4 wherein the seal comprises a compression seal formed by the weight of the lid.

6. The cooking vessel assembly according to claim 1 wherein the shape-conforming element comprises at least one of a pliable silicone and a nylon.

7. The cooking vessel assembly according to claim 1 wherein the shape-conforming element is mounted to the second portion.

8. The cooking vessel assembly according to claim 7 wherein the shape-conforming element envelopes at least a part of the second portion to mount the shape-conforming element to the second portion.

9. The cooking vessel assembly according to claim 1 wherein the shape-conforming element at least partially circumscribes the interior volume.

10. The cooking vessel assembly according to claim 9 wherein the shape-conforming element completely circumscribes the interior volume.

11. The cooking vessel assembly according to claim 1 wherein the first portion comprises a step having at least one support surface and the second portion overlies the support surface when the lid closes the opening.

12. The cooking vessel assembly according to claim 11 wherein the step further comprises a lip and the shape-conforming element abuts at least one of the support surface and lip when the lid closes the opening.

13. The cooking vessel of claim 1 wherein the shape conforming element is configured to prevent a first portion of the heat and steam from migrating out of the interior volume during cooking while allowing a second portion of the heat and steam to exit the cooking vessel between the cooking vessel and the lid.

14. The cooking vessel of claim 1 wherein the shape conforming element is a bead adhered to at least one of the first portion and the second portion.

15. A slow cooker comprising:
a cooking vessel defining an interior volume and having a first portion defining an opening to the interior volume;
a heating unit having a chamber configured to at least partially receive the cooking vessel and to heat the cooking vessel;
a lid configured to close the opening and having a second portion configured for cooperative disposition with the first portion when the lid closes the opening; and
a shape-conforming element mounted to one of the first portion and the second portion, the shape-conforming element configured to conform with the other of the first portion and the second portion when the lid closes the opening whereby heat and steam are retarded from migrating out of the interior volume.

16. The cooking vessel assembly according to claim 15 wherein the first portion is an edge on the vessel and the second portion is a peripheral rim on the lid.

17. The slow cooker according to claim 15 wherein the cooking vessel is configured to be removably received in the chamber.

18. The slow cooker according to claim 15, and further comprising a controller configured to control the operation of the heating unit.

19. The slow cooker according to claim 15 wherein the other of the first portion and the second portion has a profile and the shape-conforming element is configured to conform to the profile when the lid closes the opening.

20. The slow cooker according to claim 15 wherein the shape-conforming element is configured to form a seal between the cooking vessel and the lid.

21. The slow cooker according to claim 20 wherein the seal comprises a compression seal formed by the weight of the lid.

22. The slow cooker according to claim 15 wherein the shape-conforming element comprises at least one of a pliable silicone and a nylon plastic.

23. The slow cooker according to claim 15 wherein the shape-conforming element is mounted to the second portion.

24. The slow cooker according to claim 23 wherein the shape-conforming element envelopes at least a part of the second portion to mount the shape-conforming element to the second portion.

25. The cooking vessel assembly according to claim 15 wherein the shape-conforming element is mounted to a portion of the second portion.

26. The slow cooker according to claim 15 wherein the first portion comprises a step having at least one support surface and the second portion is configured to overlie the support surface when the lid closes the opening.

27. The slow cooker according to claim 26 wherein the step further comprises a lip and the shape-conforming element abuts at least one of the support surface and lip when the lid closes the opening.

28. The cooking vessel of claim 15 wherein the shape conforming element is a bead adhered to at least one of the first portion and the second portion.

29. A cover for a cooking device having a cooking cavity, comprising:
a lid configured to cooperatively enclose the cooking cavity, the lid having a peripheral rim; and
a pliable element mounted to the lid such that the pliable element is to be disposed at least in part between the lid and the cooking device when the lid encloses the cooking cavity.

30. The cover of claim 29 wherein the pliable element is configured to surround the peripheral rim of the lid.

31. The cover of claim 29 wherein the pliable element is further configured to retard at least a portion of heat and steam from migrating out of the cooking cavity during cooking when the lid encloses the cooking cavity.

32. The cover of claim 29 wherein the pliable element comprises at least one of silicone and nylon plastic.

33. The cooking vessel of claim 29 wherein the pliable element is a bead adhered to the lid.
